(19) United States
(12) Patent Application Publication
(10) Pub. No.: US 2012/0279992 A1
(43) Pub. Date: Nov. 8, 2012

(54) SPRAY PRODUCT SAMPLE DISPENSER AND MERCHANDISING PRODUCT DISPLAY

(75) Inventor: Andrew Zachery Wilder, Brewster, NY (US)

(73) Assignee: CONOPCO, INC., D/B/A UNILEVER, Englewood Cliffs, NJ (US)

(21) Appl. No.: 13/099,580

(22) Filed: May 3, 2011

(51) Int. Cl. B67D 7/84; B67D 7/60; B67D 7/06

(52) U.S. Cl. 222/173

(57) ABSTRACT

A spray delivered sample dispenser and merchandising unit product display is provided which includes an elongate tray and a sample dispenser. The tray is formed from a pair of side walls defining a trough having an open roof to allow a plurality of products each packaged in a container provided with spray dispensing heads to stand for sale therewithin. The sample dispenser includes a housing attached to a front end of the tray. A spray nozzle is seated in the housing. The nozzle has at least one outlet aperture for emitting a spray. The main axis traversing the outlet aperture defines a direction of spray, the outlet aperture being oriented downward toward a plane defining the floor of the trough. The main axis is positioned at an angle from 25 to 75 degree relative to the plane. A lever unit pivotably connected with the housing will actuate the nozzle to spray. A liquid reservoir of product is supported on a carriage attached to the rear end of the tray. Tubing connects the reservoir to the spray nozzle and transports liquid for ejection as a spray via the nozzle. Upon a human hand applying pressure to move the lever unit downward, a spray of product ejects from the nozzle and is intercepted by the back of the same human hand or fingers thereof.

### BACKGROUND OF THE INVENTION

1. Field of the Invention

The invention concerns a device which allows a consumer in a store prior to purchase to evaluate fragrance and other attributes of a spray delivered product.

2. The Related Art

Consumers in purchasing goods in supermarkets, drug stores, department stores and other similar retail outlets are faced with an array of product choices. Selection is not only necessary between brands but also variants within a brand. Some of these products are packaged as spray applied. These type are spray delivered by actuating a spray nozzle. Often it is the fragrance component of these products which determines a consumer's choice.

Some stores leave test sample dispensers. Usually there is very little supervision in this sampling. The mobility of the samplers often disassociates sampler from a purchasable supply of products. In other words, sampler and relevant purchasable product are not placed next to one another. It is frustrating for a consumer to like the sample yet not easily locate the purchasable item.

Another problem with spray applied systems is that they leave a cloud of product in the near environment. Not everyone appreciates navigating through a cloud of fragrance as they pass a sample display. A much more directed sampling system is needed.

U.S. patent application publication no. 2009/0294479A1 (Sottosanti et al.) describes a combined sample dispenser and merchandising unit product display for lotions and creams. Included is an elongate tray with an upper compartment having an open roof for standing a plurality of merchandising unit products. A lower compartment functioning as a reservoir for product samples is arranged directly below the upper compartment. A sample dispenser is provided which includes a dispensing unit drawing sampling amounts from the reservoir. Upward pressure on a lever of the sample dispenser ejects from above a dollop of test product.

French patent publication 2,712,471 (Clain) discloses a display unit for bottles fittable within a tray. A sampling device is arranged at a front end crafted with a reservoir filled with liquid fragrance similar to that displayed in the for sale bottles of the tray. A vertically arranged spray pump is fitted to the reservoir and can aspirate liquid upon being actuated. Disadvantageously, actuation of the nozzle and interception by a consumer's body part requires a two-handed operation. Furthermore, the main axis of the nozzle opening is directed outward at a 90 degree angle to a plane defining a bottom of the tray. Waste and vapor pollution results from this configuration. Still further, every time a new perfume or other liquid product is placed for display in sampling, the reservoir must be emptied and cleaned. This is not an easily performed operation at the retail level.

Accordingly, there is a need for a sampling system for spray applied products in which dispensing can occur one-handedly, waste is minimized, less vapor is ejected into the environment, and wherein quick changeover is possible to a different product for sampling.

### SUMMARY OF THE INVENTION

A spray applied sample dispenser and merchandising unit product display is provided which includes:
(i) an elongate tray comprising a front end and a rear end, a pair of sidewalls defining a trough with an open roof for standing a plurality of for sale products each packaged in a container provided with a spray dispensing head;
(ii) a sample dispenser including:
   (a) a housing attached to the front end of the tray;
   (b) a spray nozzle seated in the housing, the nozzle having at least one outlet aperture for emitting a spray, a main axis traversing the outlet aperture defining a direction of spray, the outlet aperture oriented downward toward a plane defining a floor of the trough, the axis being oriented at an angle from 25 to 75 degree relative to the plane;
   (c) a lever unit pivotably connected within the housing for actuating the nozzle to spray;
   (d) a liquid reservoir of product supported on a holder carriage attached to the rear end of the tray;
   (e) tubing connecting the reservoir to the spray nozzle and transporting liquid for ejection as a spray via the nozzle; and
      wherein upon a human hand applying pressure to move the lever unit downward, a spray of product ejects from the nozzle and is intercepted by a back or fingers of the human hand.

### BRIEF DESCRIPTION OF THE DRAWING

The various features and benefits of the present invention will become more apparent through consideration of the following drawing in which:

FIG. 1 is a perspective view of the sample dispenser and merchandising unit display as appearing on a retail shelf;

FIG. 2 is a partial side view of the embodiment of FIG. 1 demonstrating the one-handed operation of the sample dispenser;

FIG. 3 is a perspective view of a front housing of the sample dispenser shown in the FIG. 1 embodiment;

FIG. 4 is a rear view of the sample dispenser according to FIG. 3;

FIG. 5 is a lever component fittable into the front housing;

FIG. 6 is a pump plate engageable with the lever component of FIG. 5;

FIG. 7 is a back housing for the sample dispenser;

FIG. 8 is an adaptor plate for supporting a liquid reservoir at the rear end of the tray; and

FIG. 9 is a holder carriage for placement on the adaptor plate illustrated in FIG. 8.

### DETAILED DESCRIPTION OF THE INVENTION

Now I have invented a more efficient spray delivered sample dispenser to be used as a test of product displayed in an attached merchandising unit tray. “Spray delivered” is meant to refer to vaporized liquid dispensed from a variety of vaporizing mechanisms. These may be propellant driven (e.g. low boiling point hydrocarbons or halocarbons) or those operating with manually compressed air.

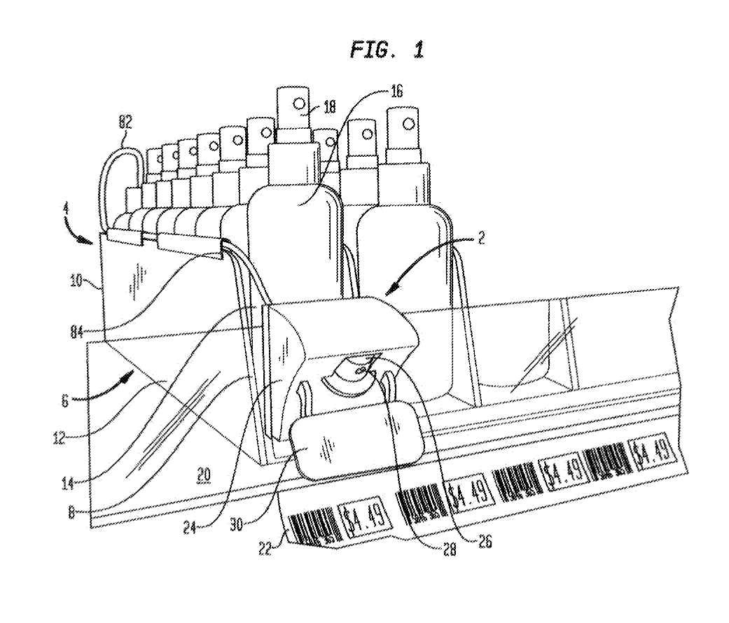

FIG. 1 illustrates in a retail environment on shelf positioning of one embodiment of the sample dispenser 2 and a merchandising unit product display 4. The merchandising unit product display features an elongate tray 6 with front and rear ends 8 and 10. The tray is constructed of a pair of parallel side walls 12 defining a trough 14 having an open roof. Within the trough may be arrayed a set of containers 16 each fitted with a spray dispensing head 18.

The spray delivered sample dispenser and merchandising product display are supported on a shelf 20 next to arrays of similar products. Along the edge of the shelf and aligned with the merchandising unit product display is store signage 22 indicating product information including bar code and price.

The sample dispenser features a housing 24 attached to the front end of the tray. A spray nozzle 26 is seated in the housing. The nozzle has at least one outlet aperture 28.

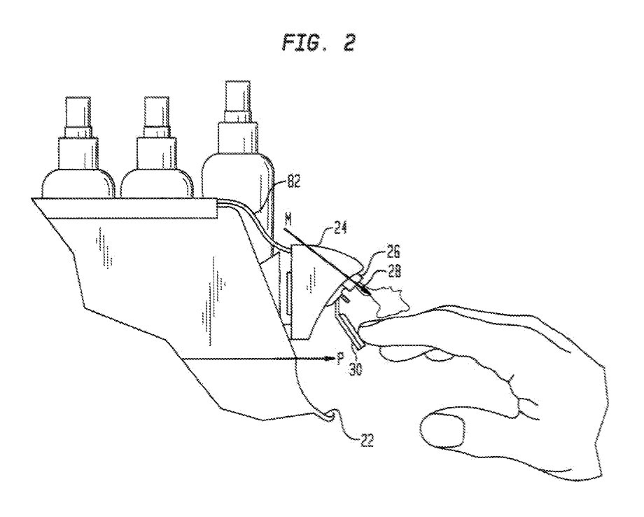

FIG. 2 best illustrates a main axis M traversing the outlet aperture and defining a direction of spray. The outlet aperture is oriented downward toward a plane P defining the floor of the trough. The main axis M is oriented to intersect with the plane P to create an angle between them of 25 to 75°, more preferably 30 to 60°.

A lever unit 30 is arranged below the spray nozzle and downwardly actuatable by pressure from a human hand.

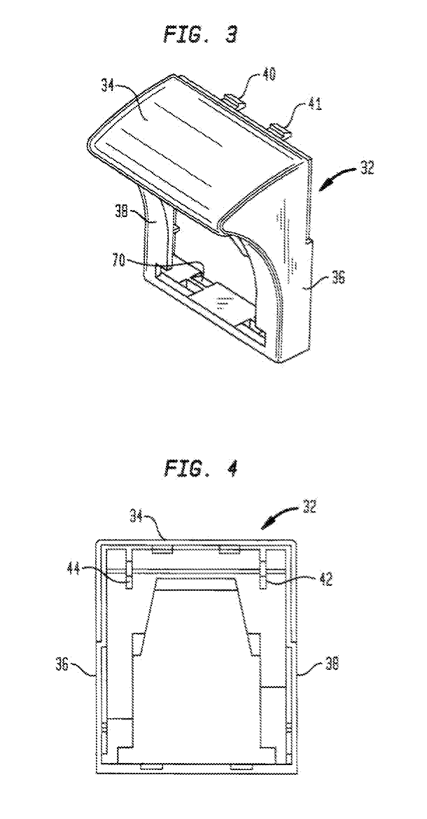

Components of the sample dispenser are illustrated in FIG. 3-7. FIG. 3 illustrates a front housing 32 featuring a hood panel 34 and left and right arms 36, 38. A pair of male clip projections 40, 41 protrude rearwardly from the hood panel. FIG. 4 illustrates a rear view of the front housing and best illustrates a set of well supports 42, 44.

FIG. 5 best illustrates the lever unit which includes a lever 35 supported from a yoke 46. A cradle 48 is formed on the yoke to receive the spray applied nozzle 26 (not shown in the Figure). The lever unit is best formed as a unitary molded plastic piece. At exterior left and right shoulders of the yoke are a pair of trunnions 50, 52. The lever unit is pivotably connected to the front housing by engagement of trunnions 50, 52 into respective well supports 42, 44 of the front housing.

FIG. 6 illustrates a pump plate 54 which seats between the lever unit and the front housing. Featured are a pair of support legs 56 and 58 flanking a hollow cylindrical tube 60. The pump plate sits directly underneath the lever unit and provides support to the spray nozzle.

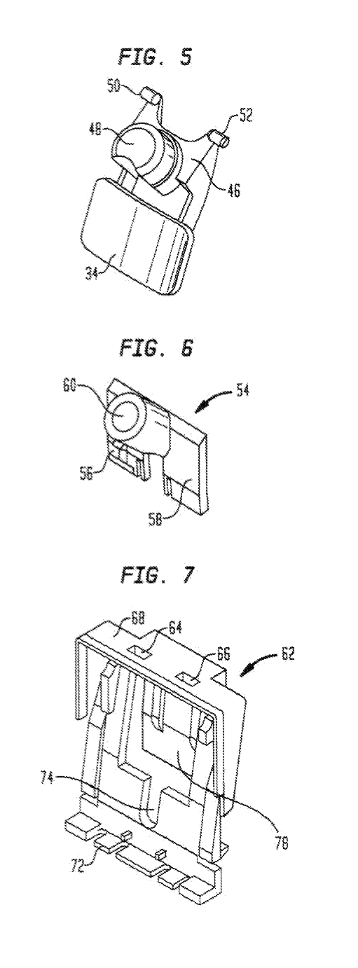

FIG. 7 illustrates the back housing 62 forming a rear element of the sample dispenser. The back housing features a pair of female receiving apertures 64, 66 in a top panel 68. Front housing 32 and back housing 62 are joined together with the male clip projections 40, 41 securingly inserting within the female receiving apertures 64, 66. Other connectivity members at lower ends of the front and back housing are the respective female indents 70 and male claws 72. Further features of the back housing are a tube entry channel 74 and a rear plate 78 for joining the sample dispenser to the merchandising product display.

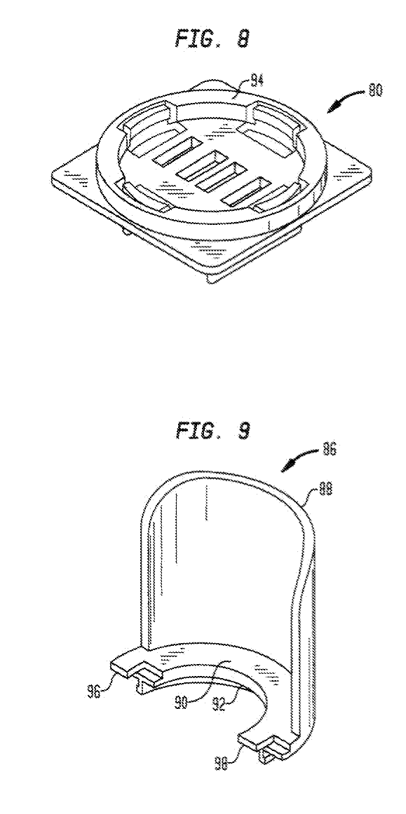

FIG. 8 illustrates an adaptor plate 80 arranged at the rear end 10 of the tray. It functions to support a sampling container 16 which is one of the products whose spray dispensing head has been removed and transferred as a nozzle to be inserted within the cradle 48 of the lever unit. In an alternate embodiment, the spray dispensing head does not come from a sampling container but rather is pre-fixed within cradle 48. A section of tubing 82 connects a diptube end of the sampling container with the spray dispensing head inserted within the lever unit. The tubing is guided between the rear end and front ends of the tray through a guide tunnel 84 positioned along a top edge of one of the tray sidewalls 12.

Use of a product container as the sampling container (instead of some specially filled reservoir) has several benefits. One is the ready availability. Another is savings on shipping of a special reservoir and no lag time in finding replacement when the container has been emptied.

FIG. 9 illustrates a holder carriage 86 having a curved retaining panel 88, a curved support platform 90 projecting inward at a lower end of the curved retaining panel, and a curved engagement member 92. The engagement member seats against an inner circumference of ring 94 of the adaptor plate. A pair of prongs 96, 98 project from opposite termini of the support platform and interlock with the rear end 10 of the tray.

In the preferred embodiment shown in FIG. 1, the elongate tray 6 is a one compartment arrangement without a second lower compartment to store any sampling liquid.

A wide variety of liquid products for spray application can be utilized with the present invention. Particularly suitable are perfumes, Eau de Toilette, antiperspirants, deodorants, hairsprays, sunscreens and the like.

What is claimed is:

1. A spray applied sample dispenser and merchandising unit product display comprising:
(i) an elongate tray comprising a front end and a rear end, a pair of sidewalls defining a trough with an open roof for standing a plurality of for sale product each packaged in a container provided with a spray dispensing head;
(ii) a sample dispenser including:
(a) a housing attached to the front end of the tray;
(b) a spray nozzle seated in the housing, the nozzle having at least one outlet aperture for emitting a spray, a main axis traversing the outlet aperture defining a direction of spray, the outlet aperture oriented downward toward a plane defining a floor of the trough, the axis being oriented at an angle from 25 to 75 degree relative to the plane;
(c) a lever unit pivotably connected within the housing for actuating the nozzle to spray;
(d) a liquid reservoir of product supported on a holder carriage attached to the rear end of the tray;
(e) tubing connecting the reservoir to the nozzle and transporting liquid for ejection as a spray via the nozzle; and
wherein upon the human hand applying pressure to move the lever downward, a spray of product ejects from the nozzle and is intercepted by a back or fingers of the same human hand.

2. The dispenser and display according to claim 1 wherein the tubing is supported along a length of the tray sidewalls.

3. The dispenser and display according to claim 1 wherein the angle ranges from 30 to 60°.

4. The dispenser and display according to claim 1 wherein the housing of the sample dispenser comprises a hood panel covering at least a portion of the spray nozzle.

5. The dispenser and display according to claim 1 wherein the housing of the sample dispenser comprises a front housing having a hood panel with a pair of pinion supports for receiving the lever unit, the lever unit having a pair of trunnions insertable within a pair of well supports and a cradle for holding the spray nozzle.

6. The dispenser and display according to claim 1 wherein the reservoir is a product filled container identical to one of the plurality of for sale products standing in the trough.

7. The dispenser and display according to claim 1 wherein the product is selected from the group consisting of antiperspirants, deodorants, hairsprays and sunscreens.

8. The dispenser and display according to claim 1 wherein the product is a perfume or an Eau de Toilette.
